(19) United States
(12) Patent Application Publication
(10) Pub. No.: US 2025/0230336 A1
(43) Pub. Date: Jul. 17, 2025

(54) IN-MOLD COATING COMPOSITIONS AND USES THEREOF

(71) Applicant: PRC-Desoto International, Inc., Sylmar, CA (US)

(72) Inventors: Matthew R. Davis, Burbank, CA (US); Lukas Surmeian, Chatsworth, CA (US); Siamanto Abrami, Glendale, CA (US)

(73) Assignee: PRC-Desoto International, Inc., Sylmar, CA (US)

(21) Appl. No.: 18/835,378

(22) PCT Filed: Jan. 24, 2023
(86) PCT No.: PCT/US2023/061120

§ 371 Date: Aug. 2, 2024

Related U.S. Application Data
(60) Provisional application No. 63/267,501, filed on Feb. 3, 2022.

(51) Int. Cl. C09D 175/08; B29C 70/54; B29K 75/00; B29K 105/08; B29K 509/08; C08G 18/24; C08G 18/42; C08G 18/73; C08K 3/36

(52) U.S. Cl. CPC C09D 175/08; C08G 18/24; C08G 18/42; C08G 18/73; B29C 70/54; B29K 2075/00; B29K 2105/0881; B29K 2509/08; C08K 3/36

(57) ABSTRACT

The in-mold coating compositions comprising a low energy can be applied over a mold release coating applied to a surface of a mold cavity. A prepreg can be applied over the in-mold coating and the in-mold coating and the prepreg simultaneously cured. The in-mold coating compositions and methods provide a finished part having a smooth pinhole-free surface coating.

### FIELD

The present disclosure relates to in-mold coating compositions and in-mold coatings. The in-mold coating compositions can be applied over a mold release coating applied to a surface of a mold cavity. A prepreg can be applied over the in-mold coating and the in-mold coating and the prepreg simultaneously cured. The method provides a finished part having a smooth, pinhole-free surface coating.

### BACKGROUND

Fiber-reinforced composite parts are widely used, for example, in the automotive and aerospace industries. Composite parts can be fabricated by laying down layers of pliable prepreg into a mold cavity to conform to the shape of the mold. Each prepreg ply can comprise reinforcing fibers such as continuous unidirectional fibers impregnated with a thermoset resin. The prepreg layup is consolidated and cured with the application of heat and pressure to provide a finished, molded composite part.

To prevent the finished molded part from adhering to the surface of the mold cavity, a mold release coating can be applied to the surface of the mold cavity before laying down the prepreg. The mold release coating enables the cured composite part to separate from the mold.

Composite parts used in the aerospace an automotive industry can require exterior surfaces to have a high-quality surface finish. Surfacing films can also provide protection to ultraviolet light and solvent resistance. Surfacing films such as topcoats can be integrated into the fabrication of composite parts to achieve a smooth pinhole-free surface.

Coatings on the exterior surface of structural parts such as topcoats, basecoats, and primers can protect the underlying structural material for degradation caused by exposure to ultraviolet light and solvents. Coatings can be applied to a structural part after the part has been fabricated. Coatings can also be applied during the molding process by first laying a multilayer film into a mold cavity and laminating the multilayer film and the structural material to form a finished part with an exterior coating.

### SUMMARY

According to the present invention, in-mold coating compositions comprise a first compound; a second compound reactive with the first compound; a rheology modifier; and a solvent, wherein the solvent comprises a low energy solvent having a surface tension less than 35 dynes/cm (mN/m) at 20° C. as determined using a Du Nouy ring.

According to the present invention, in-mold multilayer coatings comprise a mold release coating; and an in-mold coating prepared from the in-mold coating composition according to the present invention overlying the mold release coating.

According to the present invention, layups comprise the in-mold multilayer coating according to the present invention; and a prepreg overlying the in-mold multilayer coating.

According to the present invention, methods of fabricating a part having a coating comprise applying the in-mold coating composition according to the present invention over a mold release coating to provide an in-mold multilayer coating; applying a prepreg over the in-mold multilayer coating to provide a layup; and curing the layup to provide a part having a coating.

### DETAILED DESCRIPTION

For purposes of the following detailed description, it is to be understood that embodiments provided by the present disclosure may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

When reference is made to a chemical group defined, for example, by a number of carbon atoms, the chemical group is intended to include all sub-ranges of carbon atoms as well as a specific number of carbon atoms. For example, a C₂₋₁₀ alkanediyl includes a C₂₋₄ alkanediyl, C₅₋₇ alkanediyl, and other sub-ranges, a C₂ alkanediyl, a C₆ alkanediyl, and alkanediyls having other specific number(s) of carbon atoms from 2 to 10.

A coating composition refers to a curable composition used to prepare a coating. A coating composition can be applied to a surface, for example, by spraying, wiping or brushing. A coating composition can comprise a volatile solvent. After being applied to a surface, the solvent can evaporate to provide a coating. The reactants of the applied coating composition can react to first provide a partially cured coating and then fully react to provide a cured coating.

Drying time of a coating composition is determined according to ASTM D5895.

Jet Reference Fluid JRF Type I, as employed for determination of fuel resistance, has the following composition: toluene: 28%±1% by volume; cyclohexane (technical): 34%±1% by volume; isooctane: 38%±1% by volume; and tertiary dibutyl disulfide: 1%±0.005% by volume (see AMS 2629, issued Jul. 1, 1989, § 3.1.1 etc., available from SAE (Society of Automotive Engineers)).

“Number average molecular weight” refers to the total weight of a material dived by the number of molecules in the material and can be determined using gel permeation chromatography.

The particle size is determined by dynamic light scattering using a Malvern Autosizer Lo-C.

Pot life is determined by measuring the viscosity according to ASTM D1200. Pot life is the duration from the time when a coating composition is first prepared by combining the polyepoxide component, the polyamine component, and optional solvent until the time when the viscosity of the coating composition is no longer suitable for the intended application method. For example, a sprayable coating composition can have a viscosity, for example, from 20 Pa-sec to 70 Pa-sec at 25° C. as determined according to ASTM D1200 with Ford Cup Number 4.

The solids content is determined according to ISO 3251.

Solvent refers to water and/or organic solvent.

Specific gravity is determined according to ISO 787-11.

Skydrol® is a fire-resistant hydraulic fluid based on phosphate ester chemistry. Skydrol® fluids include Skydrol® 500B-4, Skydrol® LD-4, Skydrol® 5, and Skydrol® PE-5 are commercially available from Eastman Chemical Company. Skydrol® LD-4 contains 55 wt % to 65 wt % tributyl phosphate, 20 wt % to 40 wt % of butyl diphenyl phosphate, dibutyl phenyl phosphate and tributyl phosphate, less than 10 wt % 2-ethylhexyl-7-oxabicyclo[4.1.0]heptane-3-carboxylate, and 1 wt % butylated hydroxytoluene, where wt % is based on the total weight of the hydraulic fluid.

The viscosity of viscous resins and compositions is determined using a Brookfield LVT viscometer with No. 3 spindle and 60 revolutions per minute (RPM) at 20° C.

The viscosity of Newtonian or near-Newtonian compositions such as a sprayable in-mold coating composition provided by the present disclosure is determined according to ASTM D1200, Standard Test Method for Viscosity by Ford Viscosity Cup.

“Volatile organic content” (VOC) refers to is defined in 40 Code of Federal Regulations Part 15.100(s) as any compound of carbon, excluding carbon monoxide, carbon dioxide, carbonic acid, metallic carbides or carbonates, and ammonium carbonate, which participates in atmospheric photochemical reactions. Volatile organic content (VOC) is determined according to ASTM D2369.

Reference is now made to certain compounds, compositions, and methods of the present invention. The disclosed compounds, compositions, and methods are not intended to be limiting of the claims. To the contrary, the claims are intended to cover all alternatives, modifications, and equivalents.

A coating can be applied to a structural part during the fabrication process. A mold release layer can first be applied to a surface of a mold cavity. An in-mold coating composition can then be applied over the mold release layer. After solvent has evaporated from the in-mold coating composition to provide an in-mold coating, a prepreg material can be applied onto the in-mold coating. The in-mold coating and the prepreg material can be laminated under temperature and pressure to provide a structural part having a coating bonded to the prepreg.

An in-mold coating composition has a surface tension and rheology that facilitates the ability of the composition to wet and flow over the mold release layer. An in-mold coating composition can comprise, for example, a topcoat, a basecoat, or a primer.

An in-mold coating composition can have a rheology such that when applied to the surface of a panel having a mold release coating the applied in-mold coating composition wets the mold release and does not sag. An in-mold coating composition can have a rheology such that when applied to the surface of a panel having a mold release coating the applied in-mold coating composition wets the mold release and exhibits a thickness within less than +/−10% of the average thickness. For example, an applied in-mold coating having an average thickness of 2 mils (50.8 μm) can have a thickness from 1.8 mils (45.7 μm) to 2.2 mils (55.9 μm). An in-mold coating composition can have a rheology such that when applied to the surface of a panel having a mold release coating the applied in-mold coating composition wets the mold release and does not exhibit any visible pinholes and fisheyes.

An in-mold coating composition provided by the present disclosure can comprise a first compound, a second compound reactive with the first compound, a rheology modifier, and a solvent. The solvent has a low energy with a surface tension less than 35 dynes/cm (mN/m) such as less than 30 dynes/cm (mN/m) at 20° C. as determined using a Du Nouy ring.

An in-mold coating composition provided by the present disclose can comprise a thermosetting composition. The in-mold coating composition can comprise any suitable thermosetting chemistry. For example, the in-mold topcoat composition can comprise a hydroxyl/isocyanate, amine/isocyanate, epoxy/anhydride, epoxy/amine, or an epoxy/thiol curing chemistry.

An in-mold coating composition can comprise a first compound and a second compound wherein the second compound is reactive with the first compound. For example, the first and second compounds can have coreactive functional groups. For example, the first compound can comprise a polyisocyanate and the second compound can comprise a polyol. For example, the first compound can comprise a polyepoxide, and the second compound can comprise a polyanhydride, a polyamine, a polythiol, or a combination of any of the foregoing.

Each of the first compound and the second compound can independently be selected from a prepolymer, a monomer, or a combination of any of the foregoing.

A prepolymer can have a number average molecular weight, for example, less than 10,000 Da, less than 8,000 Da, less than 6,000 Da, less than 4,000 Da, or less than 2,000 Da. A prepolymer can have a number average molecular weight, for example, greater than 2,000 Da, greater than 4,000 Da, greater than 6,000 Da, or greater than 8,000 Da. A prepolymer can have a number average molecular weight, for example, from 2,000 Da to 10,000 Da, from 3,000 Da to 9,000 Da, from 4,000 Da to 8,000 Da, or from 5,000 Da to 7,000 Da.

A prepolymer can be liquid at 25° C. and can have a glass transition temperature T_{g}, for example, less than −20° C., less than −30° C., or less than −40° C., where the glass transition temperature T_{g} is determined by Dynamic Mass Analysis (DMA) using a TA Instruments Q800 apparatus with a frequency of 1 Hz, an amplitude of 20 microns, and a temperature ramp of −80° C. to 25° C., with the T_{g} identified as the peak of the tan 6 curve.

A prepolymer can exhibit a viscosity, for example, within a range from 20 poise to 500 poise (2 Pa-sec to 50 Pa-sec), from 20 poise to 200 poise (2 Pa-sec to 20 Pa-sec) or from 40 poise to 120 poise (4 Pa-sec to 12 Pa-sec), measured using a Brookfield CAP 2000 viscometer, with a No. 6 spindle, at speed of 300 rpm, and a temperature of 25° C.

A prepolymer can have a reactive functionality, for example, less than 12, less than 10, less than 8, less than 6, or less than 4. Each of the first compound and the second compound can comprise a respective reactive functionality, for example, from 2 to 12, from 2 to 8, from 2 to 6, from 2 to 4, or from 2 to 3. Each of the first compound and the second compound can independently have a functionality, for example, of 2, 3, 4, 5, 6, 7, 8, 9, 10, 11, or 12.

A prepolymer can comprises any suitable backbone. A prepolymer backbone can be selected, for example, based on the end use requirements of a vehicle part. For example, a prepolymer backbone can be selected based considerations of tensile strength, % elongation, thermal resistance, chemical resistance, low temperature flexibility, hardness, and a combination of any of the foregoing. The selection of a prepolymer for use in a particular prepolymer can also be based on cost considerations.

A prepolymer can include copolymers such as alternating copolymers, random copolymers, and/or block copolymers. For example, prepolymers can comprise segments that impart desired properties to a prepolymer backbone such as flexibility.

A prepolymer can comprise segments having different chemical structure and properties within the prepolymer backbone. The segments can be distributed randomly, in a regular distribution, or in blocks. The segments can be used to impart certain properties to the prepolymer backbone. For example, the segments can comprise flexible linkages such as thioether linkages into the polymer backbone. Segments having pendent groups can be incorporated into the prepolymer backbone to disrupt the symmetry of the prepolymer backbone. The segments can be introduced via the reactants used to prepare a sulfur-containing prepolymer and/or the lower molecular weight sulfur-containing prepolymers can be reacted with compounds containing the segments.

A prepolymer comprises a prepolymer backbone that can be terminated in suitable functional groups as appropriate for a particular curing chemistry.

A prepolymer can have any suitable backbone as appropriate for desired cured properties.

For example, a prepolymer backbone can comprise a polythioether, a polysulfide, a polyformal, a polyisocyanate, a polyurea, polycarbonate, polyphenylene sulfide, polyethylene oxide, polystyrene, acrylonitrile-butadiene-styrene, polycarbonate, styrene acrylonitrile, poly(methylmethacrylate), polyvinylchloride, polybutadiene, polybutylene terephthalate, poly(p-phenyleneoxide), polysulfone, polyethersulfone, polyethylenimine, polyphenylsulfone, acrylonitrile styrene acrylate, polyethylene, syndiotactic or isotactic polypropylene, polylactic acid, polyamide, ethylene-vinyl acetate homopolymer or copolymer, polyurethane, copolymers of ethylene, copolymers of propylene, impact copolymers of propylene, polyetheretherketone, polyoxymethylene, syndiotactic polystyrene (SPS), polyphenylene sulfide (PPS), liquid crystalline polymer (LCP), homo- and copolymer of butene, homo- and copolymers of hexene; and combinations of any of the foregoing.

Examples of other suitable prepolymer backbones include polyolefins (such as polyethylene, linear low density polyethylene (LLDPE), low density polyethylene (LDPE), high density polyethylene, polypropylene, and olefin copolymers), styrene/butadiene rubbers (SBR), styrene/ethylene/butadiene/styrene copolymers (SEBS), butyl rubbers, ethylene/propylene copolymers (EPR), ethylene/propylene/diene monomer copolymers (EPDM), polystyrene (including high impact polystyrene), poly(vinyl acetates), ethylene/vinyl acetate copolymers (EVA), poly(vinyl alcohols), ethylene/vinyl alcohol copolymers (EVOH), poly(vinyl butyral), poly(methyl methacrylate) and other acrylate polymers and copolymers (including such as methyl methacrylate polymers, methacrylate copolymers, polymers derived from one or more acrylates, methacrylates, ethyl acrylates, ethyl methacrylates, butyl acrylates, butyl methacrylates and the like), olefin and styrene copolymers, acrylonitrile/butadiene/styrene (ABS), styrene/acrylonitrile polymers (SAN), styrene/maleic anhydride copolymers, isobutylene/maleic anhydride copolymers, ethylene/acrylic acid copolymers, poly(acrylonitrile), polycarbonates (PC), polyamides, polyesters, liquid crystalline polymers (LCPs), poly(lactic acid), poly(phenylene oxide) (PPO), PPO-polyamide alloys, polysulfone (PSU), polyetherketone (PEK), polyetheretherketone (PEEK), polyimides, polyoxymethylene (POM) homo- and copolymers, polyetherimides, fluorinated ethylene propylene polymers (FEP), poly(vinyl fluoride), poly(vinylidene fluoride), poly(vinylidene chloride), and poly(vinyl chloride), polyurethanes (thermoplastic and thermosetting), aramides (such as Kevlar® and Nomex®), polytetrafluoroethylene (PTFE), polysiloxanes (including polydimethylenesiloxane, dimethylsiloxane/vinylmethylsiloxane copolymers, vinyldimethylsiloxane terminated poly(dimethylsiloxane)), elastomers, epoxy polymers, polyureas, alkyds, cellulosic polymers (such as ethyl cellulose, ethyl hydroxyethyl cellulose, carboxymethyl cellulose, cellulose acetate, cellulose acetate propionates, and cellulose acetate butyrates), polyethers and glycols such as poly(ethylene oxide)s (also known as poly(ethylene glycol)s, poly(propylene oxide)s (also known as poly(propylene glycol)s, and ethylene oxide/propylene oxide copolymers, acrylic latex polymers, polyester acrylate oligomers and polymers, polyester diol diacrylate polymers, and UV-curable resins.

Prepolymers having an elastomeric backbone can also be used. Examples of suitable prepolymers having n elastomeric backbone include polyethers, polybutadienes, fluoroelastomers, perfluoroelastomers, ethylene/acrylic copolymers, ethylene propylene diene terpolymers, nitriles, polythiolamines, polysiloxanes, and combinations of any of the foregoing.

An elastomeric prepolymer can comprise any suitable elastomeric prepolymer. Examples of suitable prepolymers having an elastomeric backbone include polyethers, polybutadienes, fluoroelastomers, perfluoroelastomers, ethylene/acrylic copolymers, ethylene propylene diene terpolymers, nitriles, polythiolamines, polysiloxanes, chlorosulfonated polyethylene rubbers, isoprenes, neoprenes, polysulfides, polythioethers, silicones, styrene butadienes, and combinations of any of the foregoing. The elastomeric prepolymer can comprise a polysiloxane, such as, for example, a polymethylhydrosiloxane, polydimethylsiloxane, polyethylhydrosiloxane, polydiethylsiloxane, or a combination of any of the foregoing. The elastomeric prepolymer can comprise terminal functional groups that have a low reactivity with amine and isocyanate groups such as silanol groups. The elastomeric prepolymer can comprise, for example, a polydimethylsiloxane prepolymer, such as a silanol-terminal polysiloxane prepolymer, such as a silanol-terminated polydimethylsiloxane prepolymer.

Examples of prepolymers having a chemically resistant backbone include polytetrafluorethylene, polyvinylidene difluoride, polyethylenetetrafluoroethylene, fluorinated ethylene propylene, perfluoroalkoxy, ethylene chlorotrifluorethylene, polychlorotrifluoroethylene, fluorinated ethylene propylene polymers polyamide, polyethylene, polypropylene, ethylene-propylene, fluorinated ethylene-propylene, polysulfone, polyarylether sulfone, polyether sulfone, polyimide, polyethylene terephthalate, polyetherketone, polyetherether ketone, polyetherimide, polyphenylene sulfide, polyarylsulfone, polybenzimidazole, polyamideimide, liquid crystal polymers, and combinations of any of the foregoing.

For parts where chemical resistance is required, prepolymers having a sulfur-containing backbone can be used. The chemical resistance can be with respect to cleaning solvents, fuels, hydraulic fluids, lubricants, oils, and/or salt spray. Chemical resistance refers to the ability of a part to maintain acceptable physical and mechanical properties following exposure to atmospheric conditions such as moisture and temperature and following exposure to chemicals such as cleaning solvents, fuels, hydraulic fluid, lubricants, and/or oils. In general, a chemically resistant part has exhibits a % swell less than 25%, less than 20%, less than 15%, or less than 10%, following immersion in a chemical for 7 days at 70° C., where % swell is determined according to EN ISO 10563.

Examples of prepolymers having a sulfur-containing backbone include polythioethers, polysulfides, sulfur-containing polyformals, monosulfides, or a combination of any of the foregoing.

Prepolymer backbones that exhibit chemical resistance can have a high sulfur content. For example, a sulfur-containing prepolymer backbone can have a sulfur content greater than 10 wt %, greater than 12 wt %, greater than 15 wt %, greater than 18 wt %, greater than 20 wt %, or greater than 25 wt %, where wt % is based on the total weight of the prepolymer backbone. A chemically resistant prepolymer backbone can have a sulfur content, for example, from 10 wt % to 25 wt %, from 12 wt % to 23 wt %, from 13 wt % to 20 wt %, or from 14 wt % to 18 wt %, where wt % is based on the total weight of the prepolymer backbone.

A monomer can have a molecular weight, for example, less than 1,000 Da, less than 800 Da less than 600 Da, less than 500 Da, less than 400 Da, or less than 300 Da. A monomer can have a molecular weight, for example, from 100 Da to 1,000 Da, from 100 Da to 800 Da, from 100 Da to 600 Da, from 150 Da, to 550 Da, or from 200 Da to 500 Da. A monomer can have a molecular weight greater than 100 Da, greater than 200 Da, greater than 300 Da, greater than 400 Da, greater than 500 Da, greater than 600 Da, or greater than 800 Da.

A reactive monomer can have a reactive functionality of two or more, for example, from 2 to 6, from 2 to 5, or from 2 to 4. A monomer can have a functionality of 2, 3, 4, 5, or 6. A monomer can have an average reactive functionality, for example, from 2 to 6, from 2 to 5, from 2 to 4, from 2 to 3, from 2.1 to 2.8, or from 2.2 to 2.6.

A monomer can comprise any suitable functional group such as, for example, a thiol, alkenyl, alkynyl, epoxy, isocyanate, Michael acceptor, Michael donor, hydroxyl, amine, silanol, polyalkoxysilyl, or other suitable reactive functional group.

A monomer can comprise, for example, a polythiol, a polyalkenyl, a polyalkynyl, a polyepoxide, a polyfunctional Michael acceptor, a polyfunctional Michael donor, a polyisocyanate, a polyol, a polyamine, a polyfunctional silanol, a polyfunctional polyalkoxysilyl, or a combination of any of the foregoing.

A monomer can comprise a polyfunctionalizing agent or a combination of polyfunctionalizing agents.

Polyfunctionalizing agents can have a functionality of three or more functional groups that can be included in a composition to increase the cross-linking density of a cured polymer matrix.

A polyfunctionalizing agent can comprise functional groups reactive with prepolymers and/or monomers.

A polyfunctionalizing agent can comprise an average functionality, for example, from 3 to 6, such as from 3 to 5, or from 3 to 4. A polyfunctionalizing agent can have a functionality of 3, 4, 5, 6, or a combination of any of the foregoing.

A polyfunctionalizing agent can comprise, for example, a polythiol, a polyalkenyl, a polyalkynyl, a polyepoxide, a polyfunctional Michael acceptor, a polyfunctional Michael donor, a polyisocyanate, a polyol, a polyamine, a polyfunctional silanol, a polyfunctional polyalkoxysilyl, or a combination of any of the foregoing.

The first compound and/or the second compound can be blocked with a moisture activated group. Moisture activated groups include silyl groups such as a trimethylsilyl blocking groups. Other moisture activated blocking groups include other silylating agents, carboxylic acid, tetrahydropyran, tetrahydrofuran, methoxyethoxymethyl groups.

The first and second compounds are coreactive and coreact to form an at least partially cured in-mold coating after being applied over a mold release layer. During subsequent processing such as when heat and pressure is applied to a layup to laminate the in-mold coating to a prepreg, the elevated temperature can cause the in-mold coating to fully cure.

An in-mold coating composition can comprise, for example, from 50 wt % to 90 wt % of a first and second compound, from 60 wt % to 90 wt %, or from 70 wt % to 90 wt % of a combination of a first and second compound, wherein wt % is based on the total solids weight of the in-mold coating composition.

An in-mold coating composition can comprise, for example, less than 90 wt % of a combination of a first and second compounds, less than 80 wt %, less than 70 wt %, or less than 60 wt % of a combination of the first and second compound, wherein wt % is based on the total solids weight of the coating composition.

An in-mold coating composition can comprise, for example, greater than 50 wt % of a combination of a first and second compound, greater than 60 wt %, greater than 70 wt %, or greater than 80 wt % of a combination of a first and second compound, wherein wt % is based on the total solids weight of the coating composition.

An in-mold coating composition provided by the present disclosure can comprise a solvent or a combination of solvents.

A solvent can comprise an organic solvent or combination of organic solvents.

A solvent can be included in the coating composition to adjust the viscosity of the coating composition to facilitate spray coating.

An in-mold topcoat composition provided by the present disclosure can comprise, for example, a low energy solvent such as a solvent having a surface tension less than 35 dynes/cm (mN/m) at 20° C. as determined using a Du Nouy ring. A low energy solvent can have a surface tension, for example, of less than 35 dynes/cm (mN/m), less than 34 dynes/cm (mN/m), less than 33 dynes/cm (mN/m), less than 32 dynes/cm (mN/m), less than 31 dynes/cm (mN/m), less than 30 dynes/cm (mN/m), less than 29 dynes/cm (mN/m) or less than 25 dynes/cm (mN/m), where surface tension is measured at 20° C. using a Du Nouy ring.

A low energy solvent can be selected to facilitate wetting the surface of a mold release layer such as the surface of a silicone-based mold release layer.

An in-mold coating composition provided by the present disclosure can comprise, for example, from 1 wt % to 20 wt % of a low energy solvent, from 2 wt % to 18 wt %, from 4 wt % to 18 wt %, or from 6 w % to 16 wt % of a low energy solvent, where wt % is based on the total weight of the in-mold coating composition. An in-mold coating composition provided by the present disclosure can comprise, for example, greater than 1 wt % of a low energy solvent, greater than 4 wt %, greater than 7 wt %, greater than 10 wt %, greater than 13 wt %, greater than 16 wt %, or greater than 19 wt % of a low energy solvent, where wt % is based on the total weight of the in-mold coating composition. An in-mold coating composition provided by the present disclosure can comprise, for example, less than 20 wt %, less than 15 wt %, less than 10 wt %, or less than 5 wt % of a low energy solvent, where wt % is based on the total weight of the in-mold coating composition.

A suitable low energy solvent for facilitating the ability of the in-mold topcoat composition to wet and flow over the surface of the release layer can comprise an aromatic hydrocarbon solvent.

For example, a suitable aromatic hydrocarbon solvent can comprise C₉₋₁₁ aromatic hydrocarbons, such as a compilation of C₇₋₁₀ dialkyl benzenes and trialkyl benzenes. A suitable aromatic hydrocarbon solvent can comprise naphtha, xylene, alkyl-substituted benzenes and combinations of any of the foregoing. Examples of suitable aromatic hydrocarbon solvents include Aromatic 100 and Aromatic 150.

An in-mold coating composition provided by the present disclosure can comprise a commercially available coating composition in which a portion of the solvent has been replaced with an aromatic hydrocarbon solvent. The amount of replacement aromatic hydrocarbon solvent can be selected to facilitate the ability of the modified commercially available coating composition to wet and flow over a silicone/hydrocarbon-based mold release layer.

An in-mold coating composition provided by the present disclosure can comprise a commercially available coating composition that has been reformulated to include a low energy solvent.

An in-mold coating composition provided by the present disclosure can comprise an additive or combination of additives.

Examples of suitable additives include fillers, adhesion promoters, reactive diluents, plasticizers, rheology modifiers, thickeners, dispersants, leveling agents, colorants/pigments, catalysts, fire retardants, antioxidants, UV stabilizers, corrosion inhibitors, erosion inhibitors, and combinations of any of the foregoing.

An in-mold coating composition provided by the present disclosure can comprise a filler or a combination of filler.

A filler can comprise, for example, inorganic filler, organic filler, low-density filler, conductive filler, or a combination of any of the foregoing.

An in-mold coating composition provided by the present disclosure can comprise, for example, from 0 wt % to 30 wt % filler, from 5 wt % to 25 wt % filler, from 7 wt % to 23 wt %, from 9 wt % to 21 wt %, from 11 wt % to 19 wt %, or from 13 wt % to 17 wt % filler, where wt % is based on the total solids weight of the coating composition. An in-mold coating composition provided by the present disclosure can comprise, for example, greater than 0 wt % filler, greater than 5 wt %, greater than 10 wt %, greater than 15 wt %, greater than 20 wt %, or greater than 25 wt % filler, where wt % is based on the total solids weight of the in-mold coating composition. An in-mold coating composition provided by the present disclosure can comprise, for example, less than 30 wt % filler, less than 25 wt %, less than 20 wt %, less than 15 wt %, less than 10 wt %, or less than 5 wt % filler, where wt % is based on the total solids weight of the in-mold coating composition.

An in-mold coating composition provided by the present disclosure can comprise an inorganic filler or combination of inorganic filler.

An inorganic filler can be included to provide mechanical reinforcement and to control the rheological properties of the in-mold coating composition. Inorganic filler may be added to compositions to impart desirable physical properties such as, for example, to increase the impact strength, to control the viscosity, to provide color and hiding, and/or to modify the electrical properties of a cured composition.

Inorganic filler useful in a coating composition can include barium sulfate, carbon black, calcium carbonate, precipitated calcium carbonate, calcium hydroxide, hydrated alumina (aluminum hydroxide), nepheline syenite, talc, mica, titanium dioxide, alumina silicate, carbonates, chalk, silicates, glass, metal oxides, graphite, silica, and combinations of any of the foregoing.

An organic filler can include color pigments such as phthalocyanine, quinacridone, and perylene.

Examples of suitable silica include silica gel/amorphous silica, precipitated silica, fumed silica, and treated silica such as polydimethylsiloxane-treated silica. An in-mold coating composition provided by the present disclosure can comprise silica gel or combination of silica gel. Examples of suitable silica gel include Gasil® silica gel available from PQ Corporation, and Sylysia®, CariAct® and Sylomask® silica gel available from Fuji Silysia Chemical Ltd.

Examples of suitable calcium carbonate filler include products such as Socal® 31, Socal® 312, Socal® U1S1, Socal® UaS2, Socal® N2R, Winnofil® SPM, and Winnofil® SPT available from Solvay Special Chemicals. A calcium carbonate filler can include a combination of precipitated calcium carbonates.

An in-mold coating composition provided by the present disclosure can comprise a filler comprising combination of silica and calcium carbonate.

Inorganic filler can be surface treated to provide hydrophobic or hydrophilic surfaces that can facilitate dispersion and/or compatibility of the inorganic filler with other components of an in-mold coating composition. An inorganic filler can include surface-modified particles such as, for example, surface modified silica. The surface of silica particles can be modified, for example, to be tailor the hydrophobicity or hydrophilicity of the surface of the silica particle. The surface modification can affect the dispensability of the particles, the viscosity, the curing rate, and/or the adhesion.

An in-mold coating composition provided by the present disclosure can comprise, for example, from 10 wt % to 40 wt % of an inorganic filler, from 15 wt % to 35 wt %, or from 20 wt % to 30 wt % of an inorganic filler, where wt % is based on the total solids weight of the in-mold coating composition. An in-mold coating composition provided by the present disclosure can comprise, for example, greater than 10 wt % of an inorganic filler, greater than 15 wt %, greater than 20 wt %, greater than 25 wt %, greater than 30 wt %, or greater than 35 wt % of an inorganic filler, where wt % is based on the total solids weight of the in-mold coating composition. An in-mold coating composition provided by the present disclosure can comprise, for example, less than 40 wt % of an inorganic filler, less than 35 wt %, less than 30 wt %, less than 25 wt %, less than 20 wt %, or less than 15 wt % of an inorganic filler, where wt % is based on the total solids weight of the in-mold coating composition.

An in-mold coating composition provided by the present disclosure can comprise an organic filler or a combination of organic filler.

Organic filler can be selected to have a low specific gravity and to be resistant to solvents such as JRF Type I and/or to reduce the density of a coating. Suitable organic filler can also have acceptable adhesion to the sulfur-containing polymer matrix. An organic filler can include solid powders or particles, hollow powders or particles, or a combination thereof.

An organic filler can have a specific gravity, for example, less than 1.15, less than 1.1, less than 1.05, less than 1, less than 0.95, less than 0.9, less than 0.8, or less than 0.7. Organic filler can have a specific gravity, for example, within a range from 0.85 to 1.15, within a range from 0.9 to 1.1, within a range from 0.9 to 1.05, or from 0.85 to 1.05.

Organic filler can comprise a thermoplastic, a thermoset, or a combination thereof. Examples of suitable thermoplastics and thermosets include epoxies, epoxy-amides, ETFE copolymers, nylons, polyethylenes, polypropylenes, polyethylene oxides, polypropylene oxides, polyvinylidene chlorides, polyvinylfluorides, TFE, polyamides, polyimides, ethylene propylenes, perfluorohydrocarbons, fluoroethylenes, polycarbonates, polyetheretherketones, polyetherketones, polyphenylene oxides, polyphenylene sulfides, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing. Organic filler can be provided in the form of solid particles.

Examples of suitable polyamide 6 and polyamide 12 particles are available from Toray Plastics as grades SP-500, SP-10, TR-1, and TR-2. Suitable polyamide powders are also available from the Arkema Group under the tradename Orgasol®, and from Evonik Industries under the tradename Vestosin®.

An organic filler can include a polyethylene powder, such as an oxidized polyethylene powder. Suitable polyethylene powders are available from Honeywell International, Inc. under the tradename ACumist®, from INEOS under the tradename Eltrex®, and Mitsui Chemicals America, Inc. under the tradename Mipelon®.

The use of organic filler such as polyphenylene sulfide in aerospace sealants is disclosed in U.S. Pat. No. 9,422,451. Polyphenylene sulfide is a thermoplastic engineering resin that exhibits dimensional stability, chemical resistance, and resistance to corrosive and high temperature environments. Polyphenylene sulfide engineering resins are commercially available, for example, under the tradenames Ryton® (Chevron), Techtron® (Quadrant), Fortron® (Celanese), and Torelina® (Toray). Polyphenylene sulfide resins are generally characterized by a specific gravity from about 1.3 to about 1.4.

An in-mold coating composition provided by the present disclosure can comprise a soft filler or combination of soft filler.

A soft filler can facilitate smoothing the surface of a cured coating by mechanical abrasion.

A soft filler refers to a filler having a hardness, for example, of less than 2.5 Mohs, less than 2.0 Mohs, or less than 1.5 Mohs.

Examples of suitable soft filler include come carbon black, kaolin, talc, gypsum, and combinations of any of the foregoing.

An in-mold coating composition provided by the present disclosure can comprise a low-density filler or a combination of low-density filler.

A low-density filler can include a low-density organic filler such as a modified, expanded thermoplastic microcapsules. Suitable modified expanded thermoplastic microcapsules can include an exterior coating of a melamine or urea/formaldehyde resin.

An in-mold coating composition can comprise low-density microcapsules. A low-density microcapsule can comprise a thermally expandable microcapsule.

Examples of suitable thermoplastic microcapsules include Expancel® microcapsules such as Expancel® DE microspheres available from AkzoNobel. Examples of suitable Expancel® DE microspheres include Expancel® 920 DE 40 and Expancel® 920 DE 80. Suitable low-density microcapsules are also available from Kureha Corporation.

Low-density filler such as low-density thermally expanded microcapsules can be characterized by a specific gravity within a range from 0.01 to 0.09, from 0.04 to 0.09, within a range from 0.04 to 0.08, within a range from 0.01 to 0.07, within a range from 0.02 to 0.06, within a range from 0.03 to 0.05, within a range from 0.05 to 0.09, from 0.06 to 0.09, or within a range from 0.07 to 0.09, wherein the specific gravity is determined according to ASTM D1475. Low-density filler such as low-density microcapsules can be characterized by a specific gravity less than 0.1, less than 0.09, less than 0.08, less than 0.07, less than 0.06, less than 0.05, less than 0.04, less than 0.03, or less than 0.02, wherein the specific gravity is determined according to ASTM D1475.

Low-density filler such as low microcapsules can be characterized by a mean particle diameter from 1 μm to 100 μm and can have a substantially spherical shape. Low-density filler such as low-density microcapsules can be characterized, for example, by a mean particle diameter from 10 μm to 100 μm, from 10 μm to 60 μm, from 10 μm to 40 μm, or from 10 μm to 30 μm, as determined according to ASTM D1475.

A low-density filler can comprise glass microspheres. For example, glass microspheres can have a bulk density, for example, from 0.1 g/cc to 0.5 g/cc and a particle size, for example, from 5 μm to 100 μm such as from 10 μm to 89 μm. Examples of suitable glass microspheres include glass bubbles available from 3M^{T}M and hollow glass microspheres available from Potters Industries.

Low-density filler such as low-density microcapsules can comprise expanded microcapsules or microballoons having a coating of an aminoplast resin such as a melamine resin. Aminoplast resin-coated particles are described, for example, in U.S. Pat. No. 8,993,691. Such microcapsules can be formed by heating a microcapsule comprising a blowing agent surrounded by a thermoplastic shell. Uncoated low-density microcapsules can be reacted with an aminoplast resin such as a urea/formaldehyde resin to provide a coating of a thermoset resin on the outer surface of the low-density microcapsules.

An in-mold topcoat composition can comprise, for example, from 1 wt % to 90 wt % of low-density filler, from 1 wt % to 60 wt %, from 1 wt % to 40 wt %, from 1 wt % to 20 wt %, from 1 wt % to 10 wt %, or from 1 wt % to 5 wt % of low-density filler, where wt % is based on the total solids weight of the in-mold coating composition.

An in-mold coating composition can comprise, for example, greater than 1 wt % low-density filler, greater than 1 wt %, greater than 2 wt %, greater than 3 wt %, greater than 4 wt %, greater than 1 wt %, or greater than 10 wt % low-density filler, where wt % is based on the total weight of the in-mold coating composition.

An in-mold coating composition can comprise from 1 vol % to 90 vol % low-density filler, from 5 vol % to 70 vol %, from 10 vol % to 60 vol %, from 20 vol % to 50 vol %, or from 30 vol % to 40 vol % low-density filler, where vol % is based on the total solids volume of the in-mold coating composition.

An in-mold coating composition can comprise greater than 1 vol % low-density filler, greater than 5 vol %, greater than 10 vol %, greater than 20 vol %, greater than 30 vol %, greater than 40 vol %, greater than 50 vol %, greater than 60 vol %, greater than 70 vol %, or greater than 80 vol % low-density filler, where vol % is based on the total solids volume of the in-mold coating composition.

An in-mold coating composition provided by the present disclosure can comprise a rheology modifier or a combination of rheology modifiers.

An in-mold coating composition can be included in an in-mold coating composition to adjust the viscosity of the coating composition and to facilitate application and to build a high film thickness. A rheology modifier can minimize settling of particulates in an in-mold coating composition and can minimize sagging of an applied in-mold coating composition.

A rheology modifier is distinguished from other reactants and additives that influence the rheological properties of an in-mold coating composition. For example, the molecular weight of the coreactants, the backbone chemistry of the prepolymers, the amount of filler, and/or the type of filler can influence the rheological properties of an in-mold coating composition.

Examples of suitable rheology modifiers include phthalates, terephathlic, isophathalic, hydrogenated terphenyls, quaterphenyls and higher or polyphenyls, phthalate esters, chlorinated paraffins, modified polyphenyl, tung oil, benzoates, dibenzoates, thermoplastic polyurethane plasticizers, phthalate esters, naphthalene sulfonate, trimellitates, adipates, sebacates, maleates, sulfonamides, organophosphates, polybutene, butyl acetate, butyl cellosolve, butyl carbitol acetate, dipentene, tributyl phosphate, hexadecanol, diallyl phthalate, sucrose acetate isobutyrate, epoxy ester of iso-octyl tallate, benzophenone, and combinations of any of the foregoing.

Examples of suitable rheology modifiers include cellulose ethers such as hydroxyethyl cellulose, alkali soluble emulsions, hydrophobically-modified alkali soluble emulsions, hydrophobically-modified ethylene oxide-based urethane, bentonite clay, smectite clay, fumed silica, and combinations of any of the foregoing.

A rheology modifier can comprise a polyether polyurethane associated thickener such as Rheolate® products available from Elementis or Rheobyk® products available from BYK.

An in-mold coating composition provided by the present disclosure can comprise, for example, from 0.1 wt % to 4.0 wt % of a rheology modifier, from 0.5 wt % to 3.0 wt %, or from 1.0 wt % to 2.0 wt % of a rheology modifier, where wt % is based on the total solids weight of the in-mold coating composition. An in-mold coating composition provided by the present disclosure can comprise, for example, greater than 0.1 wt %, greater than 0.5 wt %, greater than 1 wt %, greater than 2 wt %, or greater than 3 wt % of a rheology modifier, where wt % is based on the total solids weight of the in-mold coating composition. An in-mold coating composition provided by the present disclosure can comprise, for example, less than 4.0 wt % of a rheology modifier, less than 3.0 wt %, less than 2.0 wt %, or less than 1.0 wt % of a rheology modifier, where wt % is based on the total solids weight of the in-mold coating composition.

An in-mold coating composition provided by the present disclosure can comprise a surfactant or combination of surfactants. A surfactant can be used to reduce the surface tension of the sprayable composition and to facilitate the ability of the in-mold coating to wet the mold release layer.

An in-mold coating composition provided by the present disclosure can comprise a siloxane-based surfactant, a fluorocarbon-based surfactant or a combination thereof.

A siloxane-based surfactant can comprise an arylsiloxane surfactant.

A siloxane-based surfactant can comprise a polysiloxane ethoxylate surfactant.

A siloxane-based surfactant can comprise, for example, Stilwet® 408 and Silwet® 806, available from Momentive Performance Materials, Inc.

A surfactant can comprise a fluorocarbon-based surfactant such as Hydropalat® products available from BASF and Loxanol® CA and Elka® PL products available from BASF.

A fluorocarbon-based surfactant can comprise, for example, Capstone® FS-35 available from The Chemours Company.

An in-mold coating composition provided by the present disclosure can comprise, for example, from 0.01 wt % to 1 wt % of a surfactant, from 0.05 wt % to 0.8 wt %, from 0.1 wt % to 0.6 wt %, or from 0.2 wt % to 0.5 wt % of a surfactant or combination of surfactants, where wt % is based on the total weight of the in-mold coating composition.

An in-mold coating composition provided by the present disclosure can comprise, for example, less than 1 wt % of a surfactant, less than 0.8 wt %, less than 0.6 wt %, less than 0.4 wt %, or less than 0.2 wt % of a surfactant, where wt % is based on the total weight of the in-mold coating composition.

An in-mold coating composition provided by the present disclosure can comprise, for example, greater than 0.01 wt % of a surfactant, greater than 0.05 wt %, greater than 0.1 wt % or greater than 0.5 wt % of a surfactant, where wt % is based on the total weight of the in-mold coating composition.

An in-mold coating composition provided by the present disclosure can comprise a dispersant or combination of dispersants.

A dispersant can facilitate the suspension of particulates such as filler and pigments in the in-mold topcoat composition.

Examples of suitable dispersants include silicone-based agents, silicone-free agents such as acetylenic and alkoxylate derivatives, polymeric silicone-free agents such as acrylate or maleate derivatives, and fluoro-based agents.

A dispersant can be a high molecular weight block copolymer with pigment affinity groups.

A dispersant can comprise, for example, Disperbyk®-190 and Nuosperse® FX7500W.

A dispersant can include a salt of a carboxylic acid. Examples of suitable dispersants include Elka® FA dispersants available from BASF.

An in-mold coating composition provided by the present disclosure can comprise, for example, from 0.1 wt % to 5 wt % of a wetting agent/dispersant, from 0.5 wt % to 4 wt %, or from 1 wt % to 3 wt % of a dispersant, where wt % is based on the total solids weight of the in-mold coating composition. An in-mold coating composition provided by the present disclosure can comprise, for example, greater than 0.1 wt % of a dispersant, greater than 0.5 wt %, greater than 1 wt %, or greater than 3 wt % of a dispersant, where wt % is based on the total solids weight of the in-mold coating composition. An in-mold coating composition can comprise, for example, less than 5 wt %, less than 3 wt %, or less than 1 wt % of a dispersant, where wt % is based on the total weight of the in-mold coating composition.

An in-mold coating composition provided by the present disclosure can comprise a thickener or combination of thickeners.

Examples of suitable thickeners include polyether polyurethane resin solutions such as Rheolate® 288.

An in-mold coating composition can comprise, for example, less than 2 wt % of a thickener, less than 1 wt %, or less than 0.1 wt % of a thickener, where wt % is based on the total solids weight of the in-mold coating composition.

An in-mold coating composition provided by the present disclosure can comprise a UV stabilizer or a combination of UV stabilizers.

Examples of suitable UV stabilizers include butylated hydroxytoluene (BHT); 2-hydroxy-4-methoxy-benzophenone (e.g. UV-9); 2,4-bis(2,4-dimethyphenyl)-6-(2-hydroxy-4-octyloxyphenyl)-1,3, 5-triazine (e.g. Cyasorb® UV-1164 light absorber); 3,5-ditert-butyl-4-hydroxybenzoic acid; n-hexadecyl ester (e.g. Cyasorb® UV-2908 light stabilizer); pentaerythritol tetrakis(3-(3,5-di-tert-butyl-4-hydroxyphenyl)propionate (e.g. Irganox® 1010). Liquid hindered-amine light stabilizer from Ciba Specialty Chemicals, such as 2-(2H-benzotriazol-2-yl)-4,6-ditertpentylphenol (e.g. Tinuvin® 328), methyl 1,2,2,6,6-pentamethyl-4-piperidyl sebacate (e.g. Tinuvin® 292), decanedioic acid, bis(2,2,6,6-tetramethyl-(octyloxy)-4-piperidinyl ester (e.g. Tinuvin® 123), may also be used as suitable UV stabilizers. In addition, nanosized zinc oxide (n-ZnO) (e.g. NanoSunGuard® 3015, and NanoBYK® 3820); cerium oxide nanoparticles (n-CeO₂) (e.g. NanoBYK® 3810 or 3840); and titanium oxide nanoparticles (n-TiO₂) may also be used as UV stabilizers.

An in-mold coating composition can comprise, for example from 0.1 wt % to 5 w % of a UV stabilizer, such as from 0.5 wt % to 4 wt %, or from 1 wt % to 3 wt % of a UV stabilizer, where wt % is based on the total solids weight of the in-mold coating composition

An in-mold coating composition can comprise, for example, less than 5 wt %, less than 4 wt %, less than 3 wt %, less than 2 wt %, less than 1 wt %, or less than 0.5 wt % of a UV stabilizer, where wt % is based on the total solids weight of the in-mold coating composition

An in-mold coating composition can comprise, for example, greater than 0.1 wt %, greater than 0.5 wt %, greater than 1 wt %, greater than 2 wt %, greater than 3 wt %, or greater than 4 wt % of a UV stabilizer, where wt % is based on the total solids weight of the in-mold coating composition.

An in-mold coating composition provided by the present disclosure can comprise a solvent or combination of solvents. A solvent can be selected to reduce the surface tension of the in-mold coating composition and to be compatible with the mold release layer.

A solvent can comprise, for example of dialkyl benzenes and trialkylbenzenes.

A suitable solvent can comprise Aromatic 100, Aromatic 150, or a combination thereof.

An in-mold coating composition provided by the present disclosure can be sprayable and can wet and flow over mold release coatings

An in-mold coating composition provided by the present disclosure can be rollable or brushable and can wet and flow over mold release coatings when applied by a paint roller or paint brush

An in-mold coating composition can wet and flow over silicone-based release coatings having aliphatic hydrocarbons, cycloaliphatic hydrocarbons, or a combination thereof.

A sprayable in-mold coating composition provided by the present disclosure can have a viscosity, for example, from 20 Pa-sec to 40 Pa-sec at 25° C. measured using a Ford Cup #4 according to ASTM D1200.

A sprayable in-mold coating composition provided by the present disclosure can have a surface tension, for example, having a surface tension less than 35 dynes/cm (mN/m) such as less than 30 dynes/cm (mN/m) at 20° C. as determined using a Du Nouy ring.

A sprayable in-mold coating composition provided by the present disclosure can have a rheology, for example, from 5 Pa-s to 100 Pa-s measured using a Ford Cup #4 at 0.1 s¹ according to ASTM D1200.

A sprayable in-mold topcoat composition provided by the present disclosure can have a time to dry, for example, from 0.5 hours to 8 hours, such as from 0.5 hours to 6 hours, from 0.5 hours to 4 hours, or from 0.5 hours to 2 hours, where the drying time is determined according to ASTM D5895.

A sprayable in-mold coating composition provided by the present disclosure can be thermally curable, such as curable at a temperature, for example, from 40° C. to 120° C., such as from 40° C. to 100° C., or from 40° C. to 80° C.

An in-mold coating composition provided by the present disclosure can be a sprayable.

A sprayable in-mold coating composition can comprise, for example, from 5 wt % to 20 wt % organic solvent, from 7.5 wt % to 17.5 wt %, or from 10 wt % to 15 wt % of an organic solvent, where wt % is based on the total weight of the sprayable in-mold coating composition.

A sprayable in-mold coating composition can comprise, for example, greater than 5 wt % organic solvent, greater than 7 wt %, greater than 8 wt %, greater than 11 wt %, greater than 13 wt %, greater than 15 wt %, or greater than 17 wt % organic solvent, where wt % is based on the total weight of the sprayable in-mold coating composition.

A sprayable in-mold coating composition can comprise, for example, less than 20 wt % organic solvent, less than 20 wt %, less than 15 wt %, less than 12.5 wt %, or less than 10 wt % organic solvent, where wt % is based on the total weight of the sprayable in-mold coating composition.

An in-mold coating composition, such as a sprayable in-mold coating composition, provided by the present disclosure can have a VOC, for example, from 50 g/L to 420 g/L, from 50 g/L to 350 g/L, from 50 g/L to 300 g/L, or from 100 g/L to 250 g/L.

An in-mold coating composition provided by the present disclosure can have a VOC, for example, greater than 50 g/L, greater than 100 g/L, greater than 150 g/L, greater than 200 g/L, or greater than 250 g/L.

An in-mold coating composition provided by the present disclosure can have a VOC, for example, less than 420 g/L, less than 350 g/L, less than 300 g/L, less than 250 g/L, less than 200 g/L, less than 150 g/L, or less than 100 g/L.

An in-mold coating composition provided by the present disclosure can have a pot life, for example, of from 2 hours to 8 hours, from 2 hours to 7 hours, from 2 hours to 6 hours, or from 2 hours to 5 hours, where pot life is determined by measuring the viscosity according to ASTM D1200.

An in-mold coating composition provided by the present disclosure can have a drying time at 25° C./50% RH of from 1 hours to 4 hours, such as from 2 to 3 hours, where the drying time is determined according to ASTM D5895.

An in-mold coating composition provided by the present disclosure can have a drying time at 25° C./50% RH of less than 4 hours, less than 3 hours, or less than 1 hour, where the drying time is determined according to ASTM D5895.

An in-mold coating composition provided by the present disclosure can be a sprayable in-mold coating composition and can have a viscosity, for example, from 20 Pa-sec to 40 Pa-sec as measured at 25° C. using a Ford Cup #4 according to ASTM D1200.

An in-mold coating composition provided by the present disclosure can have any suitable viscosity. The viscosity can be, for example, suitable for use as a spreadable or extrudable in-mold coating composition. The viscosity of an in-mold coating composition provided by the present disclosure can be adjusted as desired by the addition of solvent.

An in-mold coating composition provided by the present disclosure can be sprayable. A sprayable in-mold topcoat composition can have a viscosity, for example, from 1 poise to 200 poise (0.1 Pa-sec to 20 Pa-sec), from 20 poise to 200 poise (2 Pa-sec to 20 Pa-sec), from 20 poise to 100 poise (2 Pa-sec to 10 Pa-sec), from 20 poise to 80 poise (2 Pa-sec to 8 Pa-sec), or from 30 poise to 60 poise (2 Pa-sec to 6 Pa-sec), or less than 100 poise (10 Pa-sec).

An in-mold coating composition provided by the present disclosure can be prepared form a multicomponent coating system by combining and mixing a component comprising the first compounds and a second component comprising the second compound, and as appropriate, a thinner component.

A multicomponent in-mold coating system provided by the present disclosure can comprise, for example, a polyepoxide component and a polyanhydride, component, a polyamine component, or a polythiol component. A multicomponent in-mold topcoat system provided by the present disclosure can comprise, for example, a polyisocyanate component and a polyol component.

At the time of application, the two components can be combined and mixed to form an in-mold coating composition, which can be applied to a surface.

For a sprayable in-mold coating composition, at the time of application, the two components, and a thinner component can be combined and mixed to form a sprayable in-mold coating composition, which can be applied to a surface.

A multicomponent system can be provided to a user as separate components such as a polyisocyanate component, a polyol component, and a solvent component. The separate components can be provided in separate cans, which are combined and mixed prior to application.

An in-mold multilayer coating system can comprise a mold release coating and an in-mold coating overlying the mold release coating.

A mold release coating can comprise a silicone-based mold release, a fluorocarbon-based mold release, or a combination thereof.

In an in-mold multilayer coating system provided by the present disclosure the mold release coating can comprise a silicone. A silicone can comprise, for example, (tris(n-methylamino)methylsilane, silanol-terminated polydimethylsiloxane, or a combination thereof.

A mold release coating can comprise, for example, from 1 wt % to 10 wt % of a silicone, where wt % is based on the total weight of the mold release coating.

An in-mold release coating can comprise an aliphatic hydrocarbon, a cycloaliphatic hydrocarbon, or a combination thereof. An in-mold release layer can comprise, for example, a combination of C₇₋₁₀ hydrocarbons, such as a combination of C₇₋₁₀ n-alkanes, isoalkanes, cycloalkanes, or a combination of any of the foregoing.

A mold release coating can comprise, for example, release coating comprises from 80 wt % to 99 wt % of C₇₋₁₀ hydrocarbons, where wt % is based on the total weight of the mold release coating.

Suitable fluorocarbon-based mold release compositions can comprise, for example, a fluoropolymer selected from, but are not limited to, polytetrafluoroethylene (PTFE), polyvinylidene fluoride (PVDF), polyvinylfluoride (PVF), fluorinated ethylene-propylene (FEP), polychlorotrifluoroethylene, (PCTFE), perfluoroalkoxy polymer (PFA), polyethylenetetrafluoroethylene (ETFE), polyethylene-chlorotrifluoroethylene (ECTFE), perfluoropolyether (PFPE), and a combination of any of the foregoing.

A mold release coating can have a thickness, for example, from 0.1 μm to 10 μm, such as from 0.1 μm to 5 μm. A mold-release coating can have a thickness, for example, less than 10 μm, less than 8 μm, less than 6 μm, less than 4 μm, or less than 2 μm. A mold-release coating can have a thickness, for example, greater than 0.1 μm, greater than 0.5 μm, greater than 1 μm, or greater than 2 μm.

In an in-mold multilayer coating system provided by the present disclosure, an in-mold topcoat overlies the mold release coating. An in-mold coating can be prepared by spraying an in-mold coating composition provided by the present disclosure over the mold release coating.

In an in-mold multilayer coating system provided by the present disclosure, the in-mold coating can be partially cured or have a tack free surface. A fully cured in-mold topcoat has a hardness greater than 90% of the maximum hardness of the in-mold topcoat. A partially cured coating can have a tack free surface. A tack free surface can be assessed by applying a polyethylene sheet to the surface of a coating with hand pressure and observing whether material adheres to the surface of the polyethylene sheet. A surface is tack free when no coating material is transferred to the polyethylene sheet. An in-mold coating can have a tack free time, for example, from 0.2 hours to 2 hours, from 0.2 hours to 1.5 hours, from 0.2 hours to 1 hour, or from 0.2 hours to 0.8 hours, where tack free time refers to the duration from the time when the in-mold coating is applied to the time to when the surface of the applied in-mold coating is tack free.

An in-mold coating can have an average dry film thickness, for example, from 0.5 mils (12.7 μm) to 20 mils (508 μm), from 1 mil (25.4 μm) to 18 mils (457.2 μm), or from 5 mils (127 μm) to 15 mils (381 μm). An in-mold coating can have a dry film thickness, for example, greater than 0.5 mils (12.7 μm), greater than 2 mils (50.8 μm), greater than 5 mils (127 μm), greater than 10 mils (254 μm), greater than 15 mils (381 μm), or greater than 20 mils (508 μm). An in-mold coating can have a dry film thickness, for example, less than 20 mils (508 μm), less than 15 mils (381 μm), less than 10 mils (254 μm), less than 5 mils (127 μm), or less than 1 mil (25.4 μm).

A layup provided by the present disclosure can comprise an in-mold multilayer coating system provided by the present disclosure and a prepreg overlying the in-mold multilayer coating system.

A prepreg can comprise one or more layers of prepreg.

A prepreg can comprise a composite prepreg.

In a layup provided by the present disclosure the in-mold topcoat can comprise a polyurethane-based topcoat and the prepreg can comprise a polyurethane.

In a layup provided by the present disclosure the in-mold topcoat can comprise an epoxy-based topcoat and the prepreg can comprise an epoxy.

In a layup provided by the present disclosure the in-mold topcoat can comprise a polyurethane-based topcoat and the prepreg can comprise an epoxy.

In a layup provided by the present disclosure the in-mold topcoat can be partially cured such as having a tack free surface.

A prepreg can comprise the same curing chemistry as the in-mold coating such that during lamination the prepreg and the in-mold coating can chemically bond, or the curing chemistry of the prepreg can be chemically compatible with the in-mold coating such that during lamination the prepreg and the in-mold coating can chemically bond. A compatible curing chemistry means that reactive groups of the in-mold coating can react with reactive groups of the prepreg.

Methods of fabricating a coated part can comprise applying a mold release composition to a surface of a mold cavity to provide a mold release layer; applying an in-mold topcoat composition provided by the present disclosure over the mold release layer to provide an in-mold multilayer system; applying a prepreg over the in-mold multilayer system to provide a layup; and curing the layup to provide a coated part.

The mold can be any suitable mold used to fabricate structural parts using composite prepreg materials. For example, the mold can be stainless steel.

The mold release composition can be applied to a mold cavity surface according to the method recommended by the manufacturer such as by spraying or wiping.

An in-mold coating composition provided by the present disclosure can be applied over the mold release coating by spraying using any suitable spray method. For example, an in-mold coating composition can be applied using an electrostatic air spray gun or a high-volume low pressure (HVLP) spray gun. Spraying can be done manually or using robotics.

An in-mold coating composition can be applied using one or more spraying passes to build up the coating thickness.

An in-mold coating composition can be applied over the mold release coating by rolling or brushing, with the rheology of the in-mold coating adapted for such application methods.

An in-mold coating composition provided by the present disclosure can be applied to provide a coating having a dry film thickness An in-mold coating can have a dry film thickness, for example, greater than 0.5 mils (12.7 μm), greater than 2 mils (50.8 μm), greater than 5 mils (127 μm), greater than 10 mils (254 μm), greater than 15 mils (381 μm), or greater than 20 mils (508 μm).

After an in-mold coating composition is applied to over the mold release layer the solvent can be allowed to evaporate, and the applied in-mold coating composition allowed to at least partially cure or to fully cure.

A partially cured in-mold coating refers to an applied coating that has not fully cured. A partially cured in-mold coating can have a hardness that is less than 10% of the maximum hardness of a fully cured coating. A partially cured in-mold coating can have reactive functional groups capable of chemically bonding to reciprocal reactive functional groups of compounds in an overlying layer such as an overlying polyurethane prepreg. A partially cured in-mold coating can refer to a coating provided by the present disclosure that is exposed to a temperature of 25° C. for less than 1 day following application, less than 2 days, less than 3 days, less than 4 days, or less than 5 days after forming the applied in-mold coating.

After the solvent has evaporated and the in-mold coating has at least partially cured, one or more prepreg layers can be applied over the in-mold coating.

A prepreg can comprise a layer of partially cured thermoset resin that can conform to the shape of the mold cavity. A prepreg can comprise a composite material comprising fiber embedded within a partially cured thermoset resin. The fiber can be in the form, for example, of unidirectional tows or tap, nonwoven mat, or woven fabric ply. The fiber can comprise any suitable material such as graphite, glass or metal.

The layup including the mold release coating, the in-mold coating and the one or more layers of prepreg can be cured under temperature and pressure such as in an autoclave to cause the in-mold coating and the prepreg layers to become laminated while conforming to the shape of the mold cavity.

The finished part can be removed from the mold, separating the in-mold topcoat from the mold release coating to provide a part having a coating such as a topcoat, basecoat, or primer laminated to the cured thermoset structure.

A cured in-mold coating can exhibit properties suitable for the intended purpose such as a topcoat, basecoat, or primer. A cured in-mold coating can be pin-hole free and/or can be sandable.

A cured coating provided by the present disclosure can exhibit a scratch resistance of greater than 1,000 grams following immersion in a phosphate ester-based aviation fluid for 1,000 hours at 70° C. as determined according to ISO 1518.

A cured in-mold coating provided by the present disclosure can exhibit adhesion to an aluminum substrate following immersion in water for 24 hours at 140° F. (60° C.) as determined according to ASTM D3359 with a rating of 4B or 5B.

A cured in-mold coating provided by the present disclosure can exhibit a hardness of at least 3H as determined according to ASTM D3363.

A cured in-mold coating provided by the present disclosure can exhibit solvent resistance with respect to phosphate-based ester hydraulic fluids as determined according to ASTM D5402.

A cured in-mold coating provided by the present disclosure can have a dry film thickness less than 2 mils (51 μm).

A cured in-mold coating provided by the present disclosure exhibits a scratch resistance of 1,200 grams following immersion in Skydrol® LD-4 for 1,000 hours at 70° C., as determined according to ISO 1518.

A cured in-mold coating provided by the present disclosure exhibits an adhesion of 5B to a polyurethane topcoat following water immersion as determined according to ASTM D3359.

A cured in-mold provided by the present disclosure can be chemically resistant.

Chemical resistance refers to the ability of a material such as a coating to minimize the diffusion of relevant gases and liquids through the coating such that exposure of the coating to relevant gases and liquids during the design life of the material under use conditions will not decrease the physical properties of the material below a certain threshold. The relevant gases and solvents, use conditions, product life, and threshold physical properties can depend on the specific use application. Examples of relevant solvents include high temperature gases, high temperature water, salt water, salt spray, cleaning solvents, greases, fuels, hydraulic fluids, oils, and lubricants.

Chemical resistance can be determined by measuring the % swell following immersion of a coating in a particular solvent for 7 days at a temperature of 70° C. A chemically resistant material can exhibit a % swell less than 25%, less than 20%, less than 15%, or less than 10%, following immersion in a chemical for 7 days at 70° C., where % swell is determined according to EN ISO 10563.

Other chemical resistance tests can be application specific. For example, for certain aerospace sealant applications, following exposure to Jet Reference Fluid (JRF Type 1) according to ISO 1817 for 168 hours at 60° C., a cured composition provided can exhibit a tensile strength greater than 1.4 MPa determined according to ISO 37, a tensile elongation greater than 150% determined according to ISO 37, and a hardness greater than Shore 30A determined according to ISO 868, where the tests are performed at a temperature of 23° C., and a humidity of 55% RH. Following exposure to de-icing fluid according to ISO 11075 Type 1 for 168 hours at 60° C., a cured composition can exhibit a tensile strength greater than 1 MPa determined according to ISO 37, and a tensile elongation greater than 150% determined according to ISO 37, where the tests are performed at a temperature of 23° C., and a humidity of 55% RH. Following exposure to phosphate ester hydraulic fluid (Skydrol® LD-4) for 1,000 hours at 70° C., a cured composition can exhibit a tensile strength greater than 1 MPa determined according to ISO 37, a tensile elongation greater than 150% determined according to ISO 37, and a hardness greater than Shore 30A determined according to ISO 868, where the tests are performed at a temperature of 23° C., and a humidity of 55% RH.

For aerospace applications important properties include chemical resistance such as resistance to fuels, hydraulic fluids, oils, greases, lubricants and solvents, low temperature flexibility, high temperature resistance, ability to dissipate electrical charge, and dielectric breakdown strength.

An in-mold coating composition provided by the present disclosure can be used on a surface of any suitable part. Examples of suitable parts include vehicle parts, architectural parts, construction parts, electronic parts, furniture, medical devices, portable devices, telecommunications devices, athletic equipment, apparel, and toys.

Parts such as vehicle parts including construction equipment parts, heavy machinery parts, construction equipment parts, automotive vehicle parts and aerospace vehicle parts.

A coating composition provided by the present disclosure can be used to coat internal and external vehicle parts such as motor vehicle parts, railed vehicle parts, aerospace vehicle parts, military vehicle parts, and watercraft parts.

Any suitable vehicle part can be coated using a coating composition provided by the present disclosure.

A vehicle part can be a new part or a replacement part.

The term “vehicle” is used in its broadest sense and includes all types of aircraft, spacecraft, watercraft, and ground vehicles. For example, a vehicle can include aircraft such as airplanes including private aircraft, and small, medium, or large commercial passenger, freight, and military aircraft; helicopters, including private, commercial, and military helicopters; aerospace vehicles including, rockets and other spacecraft. A vehicle can include a ground vehicle such as, for example, trailers, cars, trucks, buses, vans, construction vehicles, golf carts, motorcycles, bicycles, scooters, trains, and railroad cars. A vehicle can also include watercraft such as, for example, ships, boats, and hovercraft.

A vehicle part can be, for example, part for a motor vehicle, including automobile, truck, bus, van, motorcycles, scooters, and recreational motor vehicles; railed vehicles including trains and trams; bicycles; aerospace vehicles including airplanes, rockets, spacecraft, jets, and helicopters; military vehicles including jeeps, transports, combat support vehicles, personnel carriers, infantry fighting vehicles, mine-protected vehicles, light armored vehicles, light utility vehicles, and military trucks; and watercraft including ships, boats, and recreational watercraft.

Examples of aviation vehicles include F/A-18 jet or related aircraft such as the F/A-18E Super Hornet and F/A-18F; in the Boeing 787 Dreamliner, 737, 747, 717 passenger jet aircraft, a related aircraft (produced by Boeing Commercial Airplanes); in the V-22 Osprey; VH-92, S-92, and related aircraft (produced by NAVAIR and Sikorsky); in the G650, G600, G550, G500, G450, and related aircraft (produced by Gulfstream); and in the A350, A320, A330, and related aircraft (produced by Airbus). Methods provided by the present disclosure can be used in any suitable commercial, military, or general aviation aircraft such as, for example, those produced by Bombardier Inc. and/or Bombardier Aerospace such as the Canadair Regional Jet (CRJ) and related aircraft; produced by Lockheed Martin such as the F-22 Raptor, the F-35 Lightning, and related aircraft; produced by Northrop Grumman such as the B-2 Spirit and related aircraft; produced by Pilatus Aircraft Ltd.; produced by Eclipse Aviation Corporation; or produced by Eclipse Aerospace (Kestrel Aircraft).

A vehicle part can be an interior vehicle part or an exterior vehicle part.

A vehicle can comprise a motor vehicle and the motor vehicle part can comprise a hood, door, side panel, bumper, roof, wheel well, dashboard, seat, trunk, handle, floor, chassis, cabin, chassis, cargo bed, steering wheel, fuel tank, engine block, trim, bumper, and/or a battery casing.

A vehicle can comprise a railed vehicle and the railed vehicle part can comprise an engine and/or a rail car.

A vehicle can comprise an aerospace vehicle and the aerospace part can comprise a cockpit, fuselage, wing, aileron, tail, door, seat, interior panel, fuel tank, interior panel, flooring, and/or frame.

A vehicle can comprise a military vehicle and the military vehicle part can comprise a hood, door, side panel, bumper, roof, wheel well, dashboard, seat, trunk, handle, floor, chassis, cabin, chassis, cargo bed, steering wheel, fuel tank, engine block, trim, bumper, a mount, a turret, an undercarriage, and/or a battery casing.

A vehicle can comprise a watercraft and the watercraft part can comprise a hull, an engine mount, a seat, a handle, a chassis, a battery, a battery mount, a fuel tank, an interior accessory, flooring, and/or paneling.

A vehicle part coated using a coating composition provided by the present disclosure can have properties for the intended purpose. For example, an automotive part can be designed have a light weight. An external part for military vehicle can be designed to have a high impact strength.

A part for a commercial aerospace vehicle can be designed to have a light weight and/or to be static dissipative. An external part for a military aircraft can be designed to exhibit RFI/EMI shielding properties.

A coating composition provided by the present disclosure can be adapted to coat custom designed vehicle parts, replacement parts, upgraded parts, specialty parts, and/or high-performance parts rapidly and cost-effectively in low volume production.

An aspect of the invention includes parts comprising a coating provided by the present disclosure.

### EXAMPLES

Embodiments provided by the present disclosure are further illustrated by reference to the following examples, which describe the in-mold-coating compositions provided by the present disclosure, uses of the in-mold coating compositions and parts made using the in-mold coating compositions. It will be apparent to those skilled in the art that many modifications, both to materials and methods, may be practiced without departing from the scope of the disclosure.

### Example 1

### Polyurethane In-Mold Coating Compositions

Sprayable polyurethane coating compositions provided by the present disclosure were prepared by combining and mixing a base component (polyol component), an activator (polyisocyanate) component, and a thinner component.

The constituents of the base component, the activator component, and the thinner component are listed in Tables 1, 2, and 3, respectively.

TABLE 1
Base component (B).

| | Amount | |
|---|---|---|
| Material | (wt %) | Examples |
| ¹ Alkyd Polyester Resin | 20-30 | 1-3 |
| ² Wetting/dispersing agent | 0.5-2 | 1-3 |
| Pigment | 21-57.5 | 1-3 |
| ³ Fumed silica | 0.0-2.0 | 1-5 |
| Filler | 5-15 | 1-3 |
| ⁴ Rheology modifier | 0.1-0.5 | 1-3 |
| Sn Catalyst | 0.001-0.01 | 1-3 |
| ⁵ Solvent | 15-25 | 1-3 |
| ⁶ Aromatic hydrocarbon | 5-10 | 1-3 |

¹ _ EPS 6856 Alkyd, Alkyd polyester resin in Oxsol ® 100, available from Engineered Polymer Solutions.
² Anti-Terra ®-U 100, Salt of unsaturated polyamine amides and low molecular weight acidic polyesters, available from BYK.
³ Aerosil ® R 812 S, available from Evonik Industries.
⁴ Rheobyk ® D-410, available from BYK.
⁵ Parachlorobenzotrifluoride (PCBTF).
⁶ Naptha.

TABLE 2
Activator component (A).

| Product | Material | Amount (wt %) | Examples |
|---|---|---|---|
| ¹ Desmodur ® | Polyisocyanate | 0-100 | 1-3 |
| N-3300 A | | | |
| ² Silquest ® | Adhesion | 0-1 | 1, 2 |
| A-Link 25 Silane | promoter | | |
| n-Butyl Acetate | Solvent | 40-50 | 1, 2 |
| tert-Butyl Acetate | Solvent | 10-20 | 1, 2 |

¹ Aliphatic hexamethylene polyisocyanate trimer Available from Covestro
² Tris(3-trimethoxysilyl)propyl) isocyanurate adhesion promoter available from Momentive.

TABLE 3
Thinner Component (T).

| Product | Material | Amount (wt %) | Examples |
|---|---|---|---|
| Sn Catalyst | Catalyst | 0.1-1 | 1-3 |
| 2,4-Pentanedione | Solvent | 4-14 | 1-3 |
| Aromatic 100 | Aromatic | 80-95 | 1-3 |
| | hydrocarbon solvent | | |

### Example 2

### In-Mold Polyurethane Coating Compositions

Aluminum panels were wiped with the selected mold release composition at least 8 hours before application of the in-mold coating composition. Most commonly, gauze was used to apply the mold release composition, although brushes and paper towels were also. Up to three layers of the mold release composition was applied, waiting at least 5 minutes between applications. In some cases, the mold release panels were heat treated in a 350° F. (177° C.) oven for 30 minutes. Heating did not affect the mold release coating.

Polyurethane coating compositions were prepared as listed in Table 4.

TABLE 4
Polyurethane coating compositions.

| | Base | Activator | | Mix Ratio |
|---|---|---|---|---|
| Ex. | Component | Component | Thinner | (by weight) |
| 1 | ¹ (B) | ² (A) | ³ (T) | 3:1:0.25 |
| | Aromatic 100 | | | |
| 2 | (B) | (A) | (T) | 3:1:0.25 |
| | Xylene | | | |
| 3 | (B) | Desmodur ® | none | 10:1 |
| | Aromatic 100 | N-330A | | |
| 4 | ⁴ Desothane ® | ⁴ Desothane ® | ⁴ Desothane ® | 3:1:1.5 |
| | CA9007/T15 | CA9007B | CA9007C5 | |
| | Fumed Silica | | | |
| 5 | Desothane ® | Desothane ® | Desothane ® | 3:1:1:0.5 |
| | CA9007/T15 | CA9007B | CA9007C5 | |
| | Fumed Silica | | Aromatic 100 | |

¹ Base component described in Example 1.
² Activator component described in Example 1.
³ Thinner described in Example 1.
⁴ Desothane ® HD CA9007 polyurethane basecoat available form PPG Aerospace.

Sandable polyurethane primers of Formulations 1-3 were prepared by dispersing the pigments into the alkyd resin and the solvents by high-speed dispersion with a Cowles blade until the Hegman grind was a 5.0 NS or higher (38 μm particle size).

The viscosity of the base component was adjusted with Aromatic 100 (Examples 1 and 3) or xylene (Example 2).

For Formulations 1 and 2, the base component was combined with the activator component containing solvents and isocyanates and the thinner component containing additional aromatic solvents and an Sn catalyst. The mix ratio of Formulations 1 and 2 was 3:1:0.25 (Base/Activator/Thinner). The topcoat composition of Formulation 1 and 2 was applied by spraying with an HVLP spray gun over panels coated with a mold release, Frekote® 700-NC.

For Formulation 3, the topcoat composition did not include thinner to provide a composition having a high viscosity. The mix ratio of Formulation 3 was 10:1 (Base/Activator). The topcoat composition of Formulation 3 was applied using a paint roller with a ¼ inch nap.

For Formulations 4 and 5, a high-gloss polyurethane basecoat was prepared by adding from 0.5 wt % to 2 wt % fumed silica (Aerosil® R 812 S) to Desothane® CA9007/T15 White basecoat (available from PPG Industries Inc.). The fumed silica was added slowly under agitation, and the formulation was milled to a Hegman Grind of 7 NS (12 μm particle size).

This material was activated with a Desothane® CA9007B base component.

In Formulation 4, the combined base and activator components were reduced with Desothane® CA9007C5 thinner in a mix ratio of 3:1:1.5 (Base/Activator/Thinner).

In Formulation 5, the combined base and activator components were reduced with both Desothane® CA9007C5 thinner and Aromatic 100 in a mix ratio of 3:1:1:0.5 (Base/Activator/Thinner/Aromatic 100).

### Example 3

### Wettability of In-Mold Polyurethane Coatings to Mold Release

A summary of the materials and methods used to prepare the adhesion test panels is provided in Table 5.

TABLE 5
Test panels.

| | | In-Mold Coating | Application |
|---|---|---|---|
| Example | Mold Release | Composition | Method |
| 1 | Frekote ® 700-NC | Sandable polyurethane | Spray |
| | | primer (1) | |
| 2 | Frekote ® 700-NC | Sandable polyurethane | Spray |
| | | primer (2) | |
| 3 | Frekote ® 700-NC | Sandable polyurethane | Roll |
| | | primer (3) | |
| 4 | Frekote ® 700-NC | Desothane ® CA9007 | Spray |
| | | polyurethane basecoat (4) | |
| 5 | Frekote ® 700-NC | Desothane ® CA9007 | Spray |
| | | polyurethane basecoat (5) | |

The high gloss basecoat of Formulations 4 and 5 was applied to test panels coated with a mold release (Frekote® 700-NC) by spraying with an HVLP spray gun.

The wettability of the topcoats over the mold release composition was evaluated visually.

Topcoats that could not form a complete film exhibited fisheye defects or ran down the panel without adhering to the mold release.

The surface energy of the uncoated and top-coated surfaces was approximated using Dyne test pens. After a topcoat was wetted onto the mold release coating, the adhesion was tested by cutting a flap into the topcoat with a razor blade to determine whether the topcoat could easily peel away from the substrate.

### Example 4

Polyurethane Composite Laminates with In-Mold Sandable Polyurethane Topcoat

To prepare a part having an in-mold topcoat, a mold cavity was coated with a mold release by wiping with a soaked cloth and allowed to dry at 25° C. for 5 minutes. This process was repeated three times for three full coats. The applied mold-release was dried for at least one hour. The in-mold topcoat composition was applied by spray-coating to a thickness of about 50 μm to 100 μm (2 mils to 4 mils). After the in-mold topcoat was dry to touch (about 2 hours for Examples 1 and 2), a composite polyurethane prepreg was applied over the dry topcoat. The layup was placed in a bag, a vacuum applied, and the assembly heated in an autoclave to cure the layup. The in-mold topcoat transferred from the mold cavity to the surface of the cured prepreg and exhibited acceptable adhesion to the cured polyurethane composite.

### Example 5

### Solvent Resistance Testing

Solvent resistance of each coating is tested in accordance with American Society for Testing and Materials (ASTM) D5402 (Standard Practice for Assessing the Solvent Resistance of Organic Coatings Using Solvent Rubs). The cured coatings are rubbed back and forth 50 times using firm finger pressure with cheesecloth that is soaked in methyl ethyl ketone (MEK) solvent. Rubbing through the coating to the substrate indicates a failure of the coating due to insufficient cure. Both the coating and the cloth are visually examined for any coating removal.

### Example 6

### Skydrol® Resistance Testing

The overnight ambient cured coated panels are immersed in the hydraulic fluid Skydrol® LD-4 (available from Solutia, Inc.) at a temperature of 160° F. (71° C.) for 1,000 hours. The surfaces of the coatings are checked for paint peeling, blistering, and significant color change. Any signs of coating failure are recorded as “fail”; otherwise, the coatings are recorded as “pass”.

Within 30 min after removing the panels from the hot Skydrol® LD-4, a scratch resistance test is performed according to ISO 1518. (Paints and varnishes—Determination of scratch resistance). ISO 1518 specifies a test method for determining the scratch resistance of a single coating or a multicoat system of paint, varnish or related product to penetration by scratching with a scratch stylus loaded with a specified load. A minimum load of 1,200 gm is recorded as “Pass”. Chromic acid anodized clad 2024-T3 is used for the Skydrol® resistance test. An in-mold coating with a dry film thickness of from 0.8 mils 1.2 mils (20.3 μm to 30.5 μm) is applied to the treated aluminum substrate for Skydrol® resistance testing. A polyurethane coating is not applied on top of the coating for the test.

### Example 7

### Crosshatch Adhesion Testing

For crosshatch adhesion testing the test panels consist of a chromic acid anodized clad 2024-T3 substrate with a thickness from 0.8 mils to 1.2 mils (20.3 μm to 30.5 μm) of the primer coating and an overlying layer of a polyurethane topcoat.

Crosshatch adhesion is determined according to ASTM D3359 (Standard Test Methods for Measuring Adhesion by Tape Test), method B, 2009. A crosshatch pattern is scribed through the coating down to the substrate. A strip of 1-inch (25.4 mm) wide masking tape (such as 3M 250 or equivalent) is applied onto the scribed coating. The tape is pressed down using two passes of a 4.5-pound rubber covered roller. The tape is then removed in one abrupt motion perpendicular to the panel. The adhesion is rated by a visual examination of the coating at the crosshatch area using the provided rating system. Dry adhesion is tested after fully curing the coating system for 7 days. Wet adhesion is tested on a fully cured coating system after immersing the test panel in water at 140° F. (60° C.) for 24 hours. Panels are removed from the water, wiped dry with a paper towel, and tested after 5 minutes. The adhesion of the coating systems is rated as follows:
5B: The edges of the cuts are completely smooth and none of the lattice squares are detached.
4B: Small flakes of the coating are detached at the intersections. Less than 5% of the lattice area is affected.
3B: Small flakes of the coating are detached along edges and at intersections of cuts. The area affected is from 5% to 15% of the lattice.
2B: The coating flaked along the edges and on parts of the squares. The area affected is from 15% to 35% of the lattice.
1B: The coating flaked along the edges of cuts in large ribbons and squares have detached. The area affected is from 35% to 65% of the lattice.
0B: Flaking and detachment worse than for Grade 1B.

Finally, it should be noted that there are alternative ways of implementing the embodiments disclosed herein. Accordingly, the present embodiments are to be considered as illustrative and not restrictive. Furthermore, the claims are not to be limited to the details given herein and are entitled to their full scope and equivalents thereof.

1. An in-mold coating composition, comprising:
a first compound;
a second compound reactive with the first compound;
a rheology modifier; and
a solvent, wherein the solvent comprises a low energy solvent having a surface tension less than 35 dynes/cm (mN/m) at 20° C. as determined using a Du Nouy ring.

2. (canceled)

3. The in-mold coating composition of claim 1, wherein,
the first compound comprises a polyisocyanate and the second compound comprises a polyol, or
the first compound comprises a polyepoxide and the second compound comprises a polyanhydride, a polyamine, a polythiol, or a combination of any of the foregoing.

4-5. (canceled)

6. The in-mold coating composition of claim 1, wherein the in-mold coating composition comprises from 25 wt % to 40 wt % of a combination of the first compound and the second compound, wherein wt % is based on the total solids weight of the in-mold coating composition.

7-10. (canceled)

11. The in-mold coating composition of claim 1, wherein the rheology modifier comprises an inorganic filler.

12. (canceled)

13. The in-mold coating composition of claim 1, wherein the in-mold coating composition comprises from 1 wt % to 10 wt % of the rheology modifier, wherein wt % is based on the total solids weight of the in-mold coating composition.

14. (canceled)

15. The in-mold coating composition of claim 1, wherein the low energy solvent comprises an aromatic hydrocarbon, wherein the aromatic hydrocarbon comprises:
a combination of C₉₋₁₁ aromatic hydrocarbons;
a combination of C₉₋₁₀ dialkyl and trialkyl benzenes; or
naphtha, xylene, alkyl-substituted benzenes, or a combination of any of the foregoing.

16-18. (canceled)

19. The in-mold coating composition of claim 1, wherein the in-mold coating composition comprises from 1 wt % to 15 wt % of the low energy solvent, wherein wt % is based on the total weight of the in-mold coating composition.

20. The in-mold coating composition of claim 1, wherein the solvent comprises from 10 wt % to 50 wt % of the low energy solvent, wherein wt % is based on the total weight of the solvent.

21-23. (canceled)

24. The in-mold coating composition of claim 1, wherein the in-mold coating composition has a surface tension less than 30 dynes/cm (mN/m) at 20° C. as determined using a Du Nouy ring.

25-27. (canceled)

28. The in-mold coating composition of claim 1, wherein the in-mold coating composition comprises from 0.1 wt % to 10 wt % of a surfactant, wherein wt % is based on the total solids weight of the in-mold coating composition.

29. (canceled)

30. An in-mold coating composition, comprising:
a first compound and a second compound, wherein,
the first compound comprises a polyisocyanate and the second compound comprises a polyol; or
the first compound comprises a polyepoxide and the second compound comprises a polyanhydride, a polyamine, a polythiol, or a combination of any of the foregoing;
a rheology modifier, wherein the rheology modifier comprises an inorganic filler; and
a solvent, wherein the solvent comprises a low energy solvent having a surface tension less than 35 dynes/cm (mN/m) at 20° C. as determined using a Du Nouy ring.

31. (canceled)

32. The in-mold coating composition of claim 30, wherein,
the low energy solvent comprises a combination of C₉₋₁₁ aromatic hydrocarbons, a combination of C₉₋₁₀ dialkyl and trialkyl benzenes, or a combination thereof; and
the inorganic filler comprises fumed silica.

33. (canceled)

34. The in-mold coating composition of claim 30, wherein the in-mold coating composition comprises:
from 10 wt % to 30 wt % of the first compound;
from 10 wt % to 30 wt % of the second compound;
from 0.5 wt % to 5 wt % of the rheology modifier;
from 10 wt % to 50 wt % of the solvent; and
from 1 wt % to 15 wt % of the low energy solvent,
wherein wt % is based on the total weight of the in-mold coating composition.

35. (canceled)

36. An in-mold multilayer coating comprising:
a mold release coating; and
an in-mold coating prepared from the in-mold coating composition of claim 1 overlying the mold release coating.

37. The in-mold multilayer coating of claim 36, wherein the mold release coating comprises silicone.

38-40. (canceled)

41. The in-mold multilayer coating of claim 36, wherein the mold release coating comprises:
C₇₋₁₀ hydrocarbons; or
C₇₋₁₀ n-alkanes, isoalkanes, cycloalkanes, or a combination of any of the foregoing.

42-43. (canceled)

44. The in-mold multilayer coating of claim 36, wherein,
the mold release coating has a dry film thickness from 0.1 μm to 10 μm; and
the in-mold coating has a dry film thickness from 25 μm to 250 μm.

45-46. (canceled)

47. A layup comprising:
the in-mold multilayer coating of claim 36; and
a prepreg overlying the in-mold multilayer coating.

48. The layup of claim 47, wherein the prepreg comprises a composite prepreg and the composite prepreg comprises a polyurethane or an epoxy.

49-50. (canceled)

51. A method of fabricating a part having a coating comprising:
applying the in-mold coating composition of claim 1 over a mold release coating to provide an in-mold multilayer coating;
applying a prepreg over the in-mold multilayer coating to provide a layup; and
curing the layup to provide a part having a coating.

52-71. (canceled)
